(19) United States
(12) Patent Application Publication
(10) Pub. No.: US 2003/0145280 A1
(43) Pub. Date: Jul. 31, 2003

(54) Test executive system having XML reporting capabilities

(76) Inventors: James Grey, Cedar Park, TX (US); Eugueny Kontsevoy, Austin, TX (US)

Correspondence Address: Jeffrey C. Hood, Conley, Rose, & Tayon, P.C., P.O. Box 398, Austin, TX, 78767, US

(21) Appl. No.: 10/056,853

(22) Filed: Jan. 25, 2002

(51) Int. Cl. G06F 15/00

(52) U.S. Cl. 715/513

(57) ABSTRACT

A system and method for enabling Extensible Markup Language (XML) reporting for a test executive sequence. The test executive sequence may comprise a plurality of test executive steps operable to perform tests on a unit under test (UUT). In executing the test executive sequence, the test executive software may generate various test results, such as Boolean pass/fail results for various steps in the sequence, numeric limit values computed by various steps, etc. The test executive software may generate one or more XML files specifying the test results, i.e., the results of the execution of the test executive sequence may be represented in XML. An XSL stylesheet may then be used to transform and view the XML test results.

### FIELD OF THE INVENTION

The present invention relates to the field of test executive software for organizing and executing test executive sequences. In particular, the invention relates to a test executive system having XML reporting capabilities.

### DESCRIPTION OF THE RELATED ART

Test executive software is specialized software that allows a user to organize and execute sequences of reusable test modules to test units under test (UUTs). For example, the test modules may interact with one or more hardware instruments to test the UUT(s). The test modules often have a standard interface and typically can be created in a variety of programming environments. The test executive software operates as a control center for the automated test system. More specifically, the test executive software allows the user to create, configure, and/or control test sequence execution for various test applications, such as production and manufacturing test applications. Text executive software typically includes various features, such as test sequencing based on pass/fail results, logging of test results, and report generation, among others.

Test executives include various general concepts. The following comprises a glossary of test executive nomenclature, as used herein:

Code Module—A program module, such as a Windows Dynamic Link Library (.dll), LabVIEW VI (.vi), ActiveX component, or other type of program module or component, that implements one or more functions that perform a specific test or other action.

Test Module—A code module that performs a test of a UUT.

Step—An action that the user can include within a sequence of other actions. A step may call a test module to perform a specific test.

Step Module—The code module that a step calls.

Sequence—A series of steps that the user specifies for execution in a particular order. Whether and when a step is executed can depend on the results of previous steps.

Sequence File—A file that contains the definition of one or more sequences.

Sequence Editor—A program that provides a graphical user interface for creating, editing, and debugging sequences.

Run-time Operator Interface—A program that provides a graphical user interface for executing sequences on a production station. A sequence editor and run-time operator interface can be separate application programs or different aspects of the same program.

Test Executive Engine—A module or set of modules that provide an API for creating, editing, executing, and debugging sequences. A sequence editor or run-time execution operator interface may use the services of a test executive engine.

Application Development Environment (ADE)—A programming environment such as LabVIEW, LabWindows/CVI, Microsoft Visual C++, Microsoft Visual Basic, etc., in which the user can create test modules and run-time operator interfaces.

Unit Under Test (UUT)—The device or component that is being tested.

Thus, the user may use the sequence editor to construct a test executive sequence comprising a plurality of steps. The test executive sequence may then be executed to perform tests of a system or UUT.

In the prior art, test executive systems have provided various types of reporting capabilities for viewing or analyzing the results of a sequence execution. However, prior art test executive systems have not provided Extensible Markup Language (XML) reporting capabilities. XML provides the most flexible way to view data using browsers. It completes the de-coupling of data and presentation that was, and still is, a major objective of the World Wide Web effort. One benefit of using XML to report test executive sequence results is that the presentation of the result data is completely customizable. Instead of predefining how the data is to be viewed, e.g., as is the case with HTML-based reporting, users could customize the presentation format. For example, users could create their own XSL style sheets to display test results in any way they see fit.

It would also be desirable to enable a test executive system to generate an XML representation of a test executive object. A test executive system may define various types of objects, such as step objects, sequence objects, test results, etc. For various reasons, it would be desirable to enable the test executive system to generate XML representations of these objects. For example, an XSL stylesheet could then be applied to the XML representation to graphically display the object without requiring any graphical user interface programming on the user's part.

### SUMMARY OF THE INVENTION

One embodiment of the present invention comprises a system and method for enabling Extensible Markup Language (XML) reporting for a test executive sequence. The test executive sequence may execute under control of a test executive software application. The test executive sequence may comprise a plurality of test executive steps operable to perform any of various tests on any of various types of systems or units under test (UUTs). For example, the test executive steps may reference various user-supplied code modules operable to interact with one or more hardware devices to test the system or UUT. Test results may be generated when the test executive sequence is executed. In one embodiment, the user may specify desired test results to be collected.

According to one embodiment of the method, a test executive sequence for which XML reporting is desired may be created. For example, the test executive sequence may be created in response to user input, e.g., user input to a sequence editor that the user interacts with to create the test executive sequence, or the test executive sequence may be programmatically created. In one embodiment, XML reporting for the test executive sequence may be requested. For example, there may be multiple options for report generation, e.g., HTML report generation, plain text report generation, etc. If XML reporting is desired, then XML reporting may be specified. In another embodiment, XML reporting may be the default technique.

In one embodiment, an Extensible Stylesheet Language (XSL) stylesheet may also be created. The XSL stylesheet may be used to transformi XML test results of the test executive sequence. For example, the stylesheet may be created using a text editor or a development environment, such as Microsoft Developer Studio. In other embodiments, it may not be necessary to create an XSL style sheet. For example, in one embodiment, a plurality of pre-created XSL stylesheets may be supplied with the test executive software, and one of these pre-created XSL stylesheets may be specified. In another embodiment, the user may have previously created an XSL stylesheet that he wishes to re-use, and this existing XSL stylesheet may be specified. In another embodiment, the test executive software may supply a default XSL stylesheet which is suitable, and it may not be necessary to specify or create another XSL stylesheet.

The test executive sequence may then be executed. In executing the test executive sequence, the test executive software may generate various test results. In various embodiments, any of various types of test results may be generated. Examples of test results include Boolean pass/fail results for various steps in the sequence, numeric limit values computed by various steps, etc.

The test executive software may generate one or more XML files specifying the test results. In other words, the results of the execution of the test executive sequence may be represented in XML. The XSL stylesheet may then be used to transform and view the XML test results. For example, the XML test results may be transformed into HTML code and may be viewed using a browser application, such as Microsoft Internet Explorer. Thus, the method may advantageously enable test results of a test executive sequence to be transformed, viewed, or presented in any way desired, by defining an appropriate XSL stylesheet.

Another embodiment of the present invention comprises a system and method for generating an Extensible Markup Language (XML) representation of a test executive object. In various embodiments, the test executive software may define various types of objects used in performing tests of a system. For example, as described above, a test executive sequence may comprise a plurality of steps. These steps may be implemented as objects. In one embodiment, the test executive software may support the use of “step types”; thus, different types of steps may be implemented using different types of objects. Also, the sequence itself may be implemented as an object. Also, the test executive software may support the use of different pre-defined and/or user-defined data types, and these data types may be implemented as objects. In other embodiments, the test executive software may implement any of various other types of objects.

The test executive software may be operable to generate an XML representation for one or more of these test executive object types. In one embodiment, an XML representation may be obtained for every type of object implemented by the test executive software. In response to receiving a request for an XML representation of a specified test executive object, the test executive software may generate an XML representation of the specified test executive object. In various embodiments, the XML representation may include as much or as little information about the object as desired. For example, in one embodiment, the XML representation may include enough information about the object to enable an identical object to be re-instantiated in memory, e.g., on a different computer system. In other embodiments, the XML representation may include only a portion of the object information.

The test executive object may be specified in any of various ways, and the request for the XML representation of the object may be received in any of various ways. In one embodiment, the test executive software may provide an application programming interface (API) that includes a function or method that takes an object as a parameter and generates an XML representation of the object. In another embodiment, each test executive object may have a method for generating the XML representation of that object.

An XML representation of a test executive object may be utilized for any of various purposes. For example, in one embodiment, an XML representation may be used to create a graphical presentation or view of a test executive object. For example, it may be desirable to view the object data to enable the data to be edited by a user. As another example, it may be desirable to create a view of the object data that can be published on the World Wide Web for viewing by others. An XSL stylesheet may be used in transforming the XML object data and creating the view. In one embodiment, a default XSL stylesheet may be provided for each type of test executive object. The use of the XML representation and the XSL stylesheet may together enable the test executive object to be graphically displayed without requiring any graphical user interface programming on the user's part.

In another embodiment, an XML representation of an object may be utilized for debugging purposes. For example, a user may request an XML file representation of a test executive sequence to be generated, so that the XML file can be sent to a technical support representative of the test executive software vendor. The technical support representative may use the XML file to re-create the test executive sequence and answer the user's questions.

### BRIEF DESCRIPTION OF THE DRAWINGS

A better understanding of the present invention can be obtained when the following detailed description of the preferred embodiment is considered in conjunction with the following drawings, in which:

FIG. 1 illustrates an instrumentation control system according to one embodiment of the present invention;

FIG. 2 is a block diagram of the computer system of FIG. 1;

FIG. 3 illustrates a test executive application software architecture according to one embodiment of the present invention;

FIG. 4 illustrates one example of a test executive sequence, created according to one embodiment of a test executive application;

FIG. 5 illustrates an exemplary dialog box for a test executive step, which enables the user to specify various properties for the step that affect the way the test executive software manages the execution of the step;

FIG. 6 is a flowchart diagram illustrating one embodiment of a method for enabling Extensible Markup Language (XML) reporting for a test executive sequence;

FIG. 7 illustrates the result of viewing HTML code using a browser application, wherein the HTML code results from the transformation of XML test result data using an XSL stylesheet;

FIG. 8 is a flowchart diagram illustrating one embodiment of a method for generating an Extensible Markup Language (XML) representation of a test executive object; and

FIG. 9 illustrates a form showing an exemplary use of an XML representation of a test executive step object, i.e., an object that represents a test executive step.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Incorporation by Reference

The following references are hereby incorporated by reference in their entirety as though fully and completely set forth herein.

U.S. patent application Ser. No. 09/259,162 titled “Test Executive System and Method Including Step Types for Improved Configurability,” filed Feb. 26, 1999.

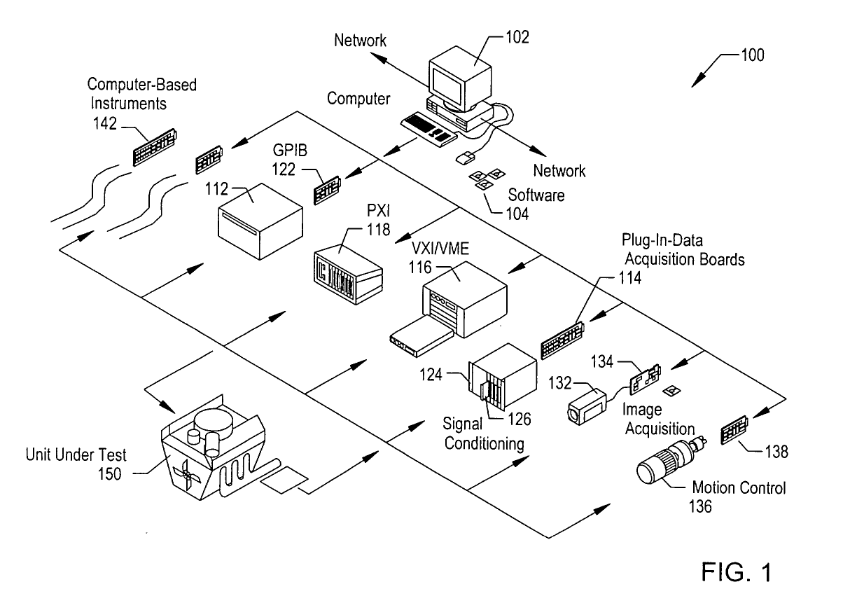

FIG. 1—Instrumentation System

FIG. 1 illustrates an exemplary instrumentation control system 100. The system 100 comprises a host computer 102 that connects to one or more instruments. The host computer 102 comprises a CPU, a display screen, memory, and one or more input devices such as a mouse or keyboard as shown. The computer 102 may execute a test executive sequence operable to analyze, measure, or control a unit under test (UUT) or process 150. For example, the test executive sequence may include various steps referencing code modules operable to connect through the one or more instruments to analyze, measure, or control the unit under test (UUT) or process 150. It is noted that FIG. 1 is exemplary only, and the present invention may be used in conjunction with any of various systems, as desired.

The one or more instruments may include a GPIB instrument 112 and associated GPIB interface card 122, a data acquisition board 114 and associated signal conditioning circuitry 124, a VXI instrument 116, a PXI instrument 118, a video device 132 and associated image acquisition card 134, a motion control device 136 and associated motion control interface card 138, and/or one or more computer based instrument cards 142, among other types of devices.

The GPIB instrument 112 may be coupled to the computer 102 via a GPIB interface card 122 provided by the computer 102. In a similar manner, the video device 132 may be coupled to the computer 102 via the image acquisition card 134, and the motion control device 136 may be coupled to the computer 102 through the motion control interface card 138. The data acquisition board 114 may be coupled to the computer 102, and optionally interfaces through signal conditioning circuitry 124 to the UUT. The signal conditioning circuitry 124 preferably comprises an SCXI (Signal Conditioning eXtensions for Instrumentation) chassis comprising one or more SCXI modules 126.

The GPIB card 122, the image acquisition card 134, the motion control interface card 138, and the DAQ card 114 are typically plugged in to an I/O slot in the computer 102, such as a PCI bus slot, a PC Card slot, or an ISA, EISA or MicroChannel bus slot provided by the computer 102. However, these cards 122, 134, 138 and 114 are shown external to computer 102 for illustrative purposes. The cards 122, 134, 138 and 114 may also be implemented as external devices coupled to the computer 102, such as through a serial bus.

The VXI chassis or instrument 116 may be coupled to the computer 102 via a serial bus, MXI bus, or other serial or parallel bus provided by the computer 102. The computer 102 preferably includes VXI interface logic, such as a VXI, MXI or GPIB interface card (not shown), which interfaces to the VXI chassis 116. The PXI chassis or instrument is preferably coupled to the computer 102 through the computer's PCI bus.

A serial instrument (not shown) may also be coupled to the computer 102 through a serial port, such as an RS-232 port, USB (Universal Serial bus) or IEEE 1394 or 1394.2 bus, provided by the computer 102. In typical systems an instrument will not be present of each interface type, and in fact many systems may only have one or more instruments of a single interface type, such as only GPIB instruments.

The instruments are coupled to the unit under test (UUT) or process 150, or are coupled to receive field signals, typically generated by transducers. Other types of instruments or devices may be connected to the system, as desired.

The computer 102 may include a memory medium on which test executive software according to one embodiment of the present invention is stored. The test executive software may allow a user to create, configure, and/or control test executive sequence execution for various test applications, such as production and manufacturing test applications. The test executive sequence executed by the computer system 102 to analyze, measure, or control the unit under test (UUT) or process 150 may execute under control of this test executive software. As described below, the test executive software may include functionality for enabling XML reporting of test results of the test executive sequence. The test executive software may also enable an XML representation to be generated for one or more test executive objects.

The term “memory medium” is intended to include an installation medium, e.g., a CD-ROM, floppy disks 104, or tape device; a computer system memory or random access memory such as DRAM, SRAM, EDO RAM, Rambus RAM, etc.; or a nonvolatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer that connects to the first computer over a network, such as the Internet. In the latter instance, the second computer may provide program instructions to the first computer for execution. The host computer CPU executing code and data from the memory medium may comprise a means for implementing the methods described below.

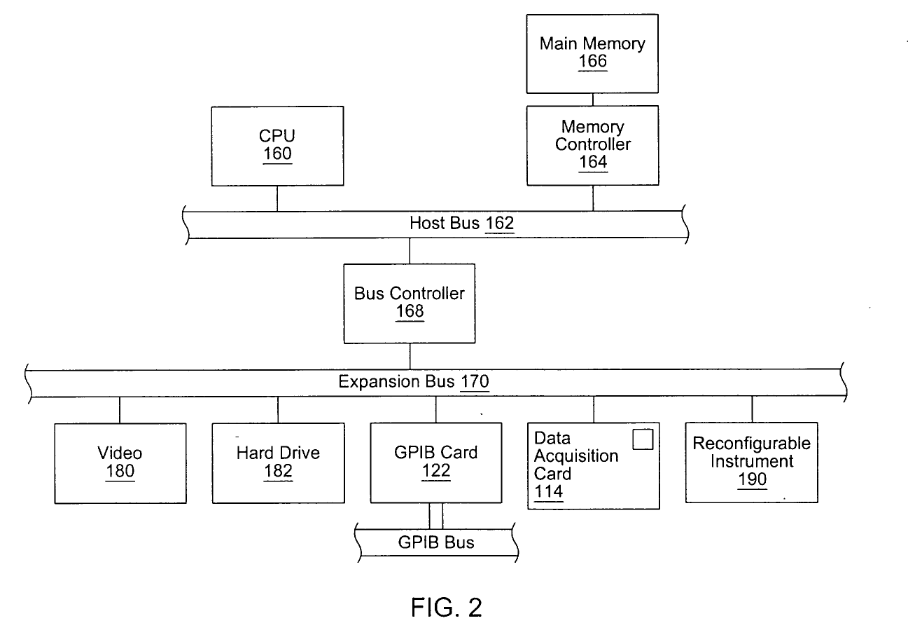

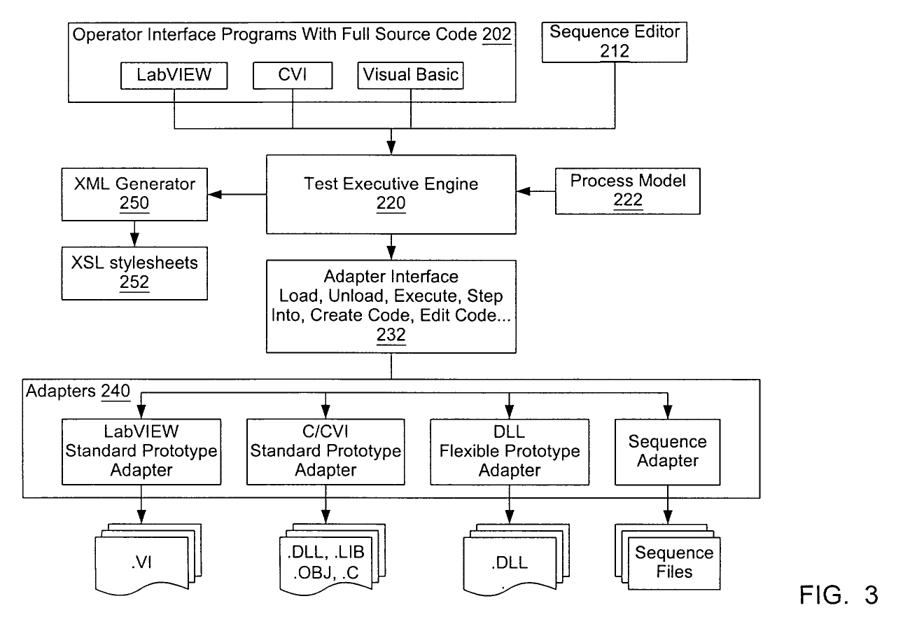

FIG. 2—Computer System Block Diagram

FIG. 2 is a block diagram of the computer system illustrated in FIG. 1. It is noted that any type of computer system configuration or architecture can be used as desired, and FIG. 2 illustrates a representative PC embodiment. It is also noted that the computer system may be a general purpose computer system as shown in FIG. 1, a computer implemented on a VXI card installed in a VXI chassis, a computer implemented on a PXI card installed in a PXI chassis, or other types of embodiments. Elements of a computer not necessary to understand the present invention have been omitted for simplicity.

The computer 102 includes at least one central processing unit or CPU 160 that is coupled to a processor or host bus 162. The CPU 160 may be any of various types, including an x86 processor, e.g., a Pentium class, a PowerPC processor, a CPU from the SPARC family of RISC processors, as well as others. Main memory 166 is coupled to the host bus 162 by means of memory controller 164.

The main memory 166 may store software according to one embodiment of the present invention, such as test executive software with functionality as described above with reference to FIG. 1. The main memory 166 may also store operating system software as well as other software for operation of the computer system, as well known to those skilled in the art.

The host bus 162 is coupled to an expansion or input/output bus 170 by means of a bus controller 168 or bus bridge logic. The expansion bus 170 may be the PCI (Peripheral Component Interconnect) expansion bus, although other bus types can also be used. The expansion bus 170 may include slots for various devices such as the data acquisition board 114 (of FIG. 1) and a GPIB interface card 122 that provides a GPIB bus interface to the GPIB instrument 112 (of FIG. 1). The computer 102 further comprises a video display subsystem 180 and hard drive 182 coupled to the expansion bus 170.

As shown, a reconfigurable instrument 190 may also be connected to the computer 102. The reconfigurable instrument 190 may include a functional unit, also referred to as configurable logic, such as a programmable logic device (PLD), e.g., an FPGA, or a processor and memory, which may execute a real time operating system. Program instructions may be downloaded and executed on the reconfigurable instrument 190. In one embodiment, at least a portion of the test executive software described herein may execute on the reconfigurable instrument 190. In various embodiments, the functional unit may be comprised on an instrument or device connected to the computer through means other than an expansion slot, e.g., the instrument or device may be connected via an IEEE 1394 bus, USB, or other type of port. Also, the functional unit may be comprised on a device such as the data acquisition board 114 or another device shown in FIG. 1.

Test Executive Software Components

FIG. 3 is a block diagram illustrating high-level architectural relationships between elements of one embodiment of a test executive software application. It is noted that FIG. 3 is exemplary, and the present invention may be utilized in conjunction with any of various test executive software applications or architectures. In one embodiment, the elements of FIG. 3 are comprised in the TestStand test executive product from National Instruments. As shown, the test executive software of FIG. 3 includes operator interface programs 202 for interfacing to various software programs. The operator interface programs 202 shown in FIG. 3 are for creating operator interface programs using the LabVIEW, LabWindows/CVI, and Visual Basic application development environments. However, additional operator interface programs 202 may be included for development with other application development environments.

The test executive software of FIG. 3 also includes a sequence editor 212 for creating and editing test executive sequences. The sequence editor 212 and the operator interface programs 202 interface to the test executive engine 220. One or more process models 222 couple to the test executive engine 220. The test executive engine 220 interfaces through an adapter interface 232 to one or more adapters 240. The adapters shown in FIG. 3 include the LabVIEW standard prototype adapter, the C/CVI prototype adapter, the DLL flexible prototype adapter, and the sequence adapter. The LabVIEW standard prototype adapter interfaces to program modules having a .VI extension, i.e., LabVIEW graphical programs. The C/CVI prototype adapter interfaces to program modules having a .dll, lib, .obj, or .c extension. The DLL flexible prototype adapter interfaces to program modules having a .dll extension. The sequence adapter interfaces to sequence files.

The test executive engine 220 manages the execution of test executive sequences. Sequences comprise steps that may call external code modules. By using module adapters 240 that have the standard adapter interface 232, the test executive engine 220 can load and execute different types of code modules. Thus, the test executive may be independent from particular application development environments (ADEs) used to create the code modules. In one embodiment, the test executive may use a special type of sequence called a process model to direct the high-level sequence flow. The test executive engine 220 may implement an API used by the sequence editor 212 and run-time operator interfaces 202.

Test Executive Sequence Editor

The sequence editor 212 may be an application program in which the user creates, modifies, and/or debugs test executive sequences. The sequence editor 212 may have a graphical user interface (GUI) enabling a user to efficiently create a test executive sequence for testing a system or unit under test. For example, the sequence editor 212 may provide the user with easy access to test executive features, such as step types, step properties, sequence parameters, step result collection, etc.

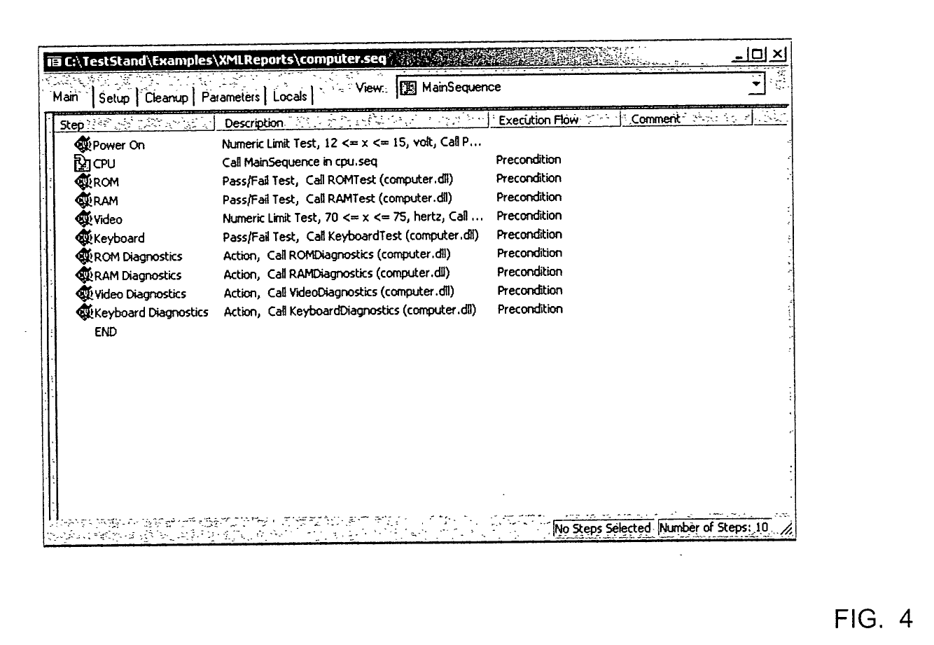

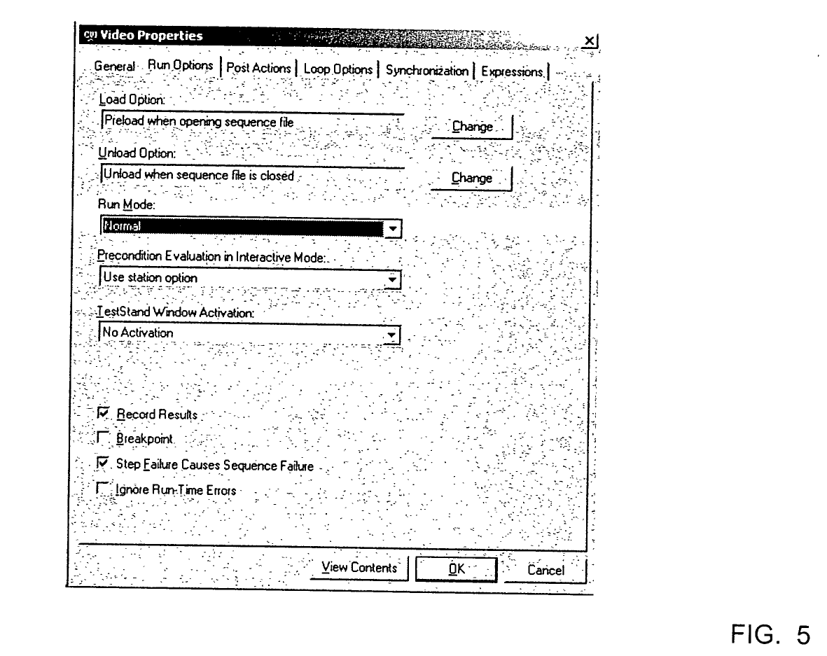

FIG. 4 illustrates one example of a test executive sequence, created according to one embodiment of a sequence editor 212. The exemplary sequence of FIG. 4 comprises a plurality of test executive steps operable to test various aspects of a computer system. For example, the sequence includes a “ROM” step to test the computer's read-only memory, a “RAM” step to test the computer's random access memory, etc. Each step may call an external code module that interacts with the computer system to perform the desired test. The user may also specify various properties for each step that affect the way the test executive software manages the execution of the step. For example, FIG. 5 illustrates an exemplary dialog box for the “Video” step. As shown, a “Run Options” property page is selected in FIG. 5. The “Run Options” property page enables the user to specify various options for the step, such as whether to record test results for the step, whether to break execution when the step is reached, whether to pre-load the step when opening the sequence file, etc.

In one embodiment, the sequence editor 212 may also include an execution window that provides debugging tools such as those found in application development environments such as LabVIEW, LabWindows/CVI, Microsoft Visual C/C++, Microsoft Visual Basic, etc. These may include features such as breakpoints, single stepping, tracing, a variable display, a watch window, etc.

In one embodiment, in the sequence editor 212, the user may start multiple concurrent executions. Multiple instances of the same sequence can be executed, and different sequences can be executed at the same time, e.g., as separate threads in a multi-threaded system. Each execution instance may have its own execution window. In trace mode, the execution window may display the steps in the currently executing sequence. When execution is suspended, the execution window may display the next step to execute and provide single-stepping options.

Test Executive Engine

The test executive engine 220 may be used when creating, editing, executing, and debugging test executive sequences. The test executive engine 220 may also provide a test executive engine application programming interface (API) that enables another program to interface with the test executive engine 220 in order to perform these actions. In one embodiment, the test executive engine 220 may export an object-based or component-based API, which in one embodiment may be an ActiveX Automation API. The sequence editor 212 and run-time operator interfaces 202 may use the test executive engine API. The engine API may be called from any programming environment able to use the API. For example, where the API comprises an ActiveX Automation API, the engine API may be called from any programming environment that supports access to ActiveX Automation servers. Thus, in various embodiments, the engine API may be called from test modules written in various programming environments, including test modules that are written in LabVIEW, LabWindows/CVI, Microsoft Visual C++, Microsoft Visual Basic, Java, etc.

One task performed by the test executive engine 220 is to manage the execution of test executive sequences. Executing a sequence may comprise executing steps included in the sequence. Not all steps in the sequence are necessarily executed. For example, the user may configure some steps to be skipped, e.g., depending on execution results of previous steps. For a step that references a user-supplied code module, executing the step may comprise executing the respective code module. In addition to these user-supplied code modules being executed, for each step, additional program instructions may be executed, wherein these additional program instructions implement additional functionality specified for the step. These additional program instructions may be specified by the test executive software, rather than being defined by the respective user-supplied code module for the step. As one example, when including a step in a sequence, the user may configure execution results of the step to be collected. In this example, when the step is executed, program instructions to store the step results accordingly may be executed in addition to the program instructions of a user-supplied code module that the step references. It is noted that not all steps may reference a user-supplied code module. For example, the test executive may provide some step types that primarily affect various aspects of sequence execution and are not designed to reference user-supplied code modules.

XML Generator

The test executive engine 220 may include or interact with an XML generator 250. In one embodiment, the XML generator 250 may be operable to generate XML report data for execution of a test executive sequence. One embodiment of a method for performing XML reporting for a test executive sequence is described below. In one embodiment, the XML generator 250 may be operable to generate an XML representation of a test executive object, e.g., for a step object, a sequence object, a test result, etc. One embodiment of a method for generating an XML representation of a test executive object is described below.

As shown, the test executive software may also include one or more XSL stylesheets 250. For example, a default XSL stylesheet may be provided for transforming, presenting, and/or viewing XML test result data for a test executive sequence. Also, default XSL stylesheets for various test executive objects may be provided, so that an XML representation of an object may be transformed, presented, and/or viewed in various ways. Also, the test executive software may enable users to supply their own stylesheets, to customize the transformation of XML data.

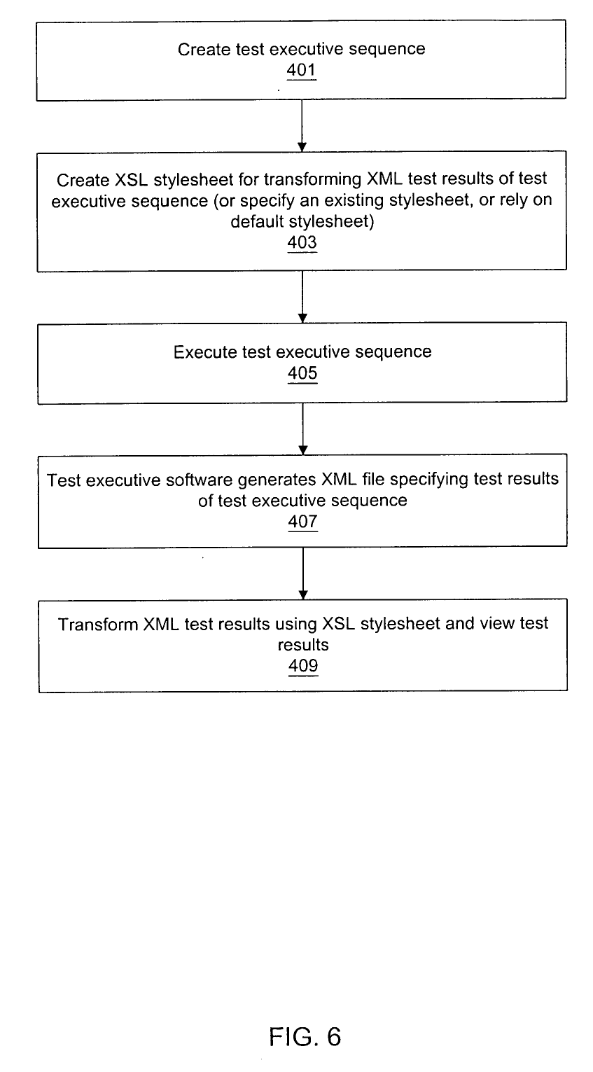

FIG. 6—XML Reporting for a Test Executive Sequence

FIG. 6 is a flowchart diagram illustrating one embodiment of a method for enabling Extensible Markup Language (XML) reporting for a test executive sequence. The test executive sequence may execute under control of a test executive software application. The test executive sequence may comprise a plurality of test executive steps operable to perform any of various tests on any of various types of systems or units under test (UUTs). For example, the test executive steps may reference various user-supplied code modules operable to interact with one or more hardware devices to test the system or UUT. Test results may be generated when the test executive sequence is executed. In one embodiment, the user may specify desired test results to be collected.

In step 401 of the method, a test executive sequence for which XML reporting is desired may be created. For example, the test executive sequence may be created in response to user input, e.g., user input to a sequence editor 212 that the user interacts with to create the test executive sequence, or the test executive sequence may be programmatically created. In one embodiment, XML reporting for the test executive sequence may be requested. For example, there may be multiple options for report generation, e.g., HTML report generation, plain text report generation, spreadsheet report generation, etc. If XML reporting is desired, then XML reporting may be specified. In another embodiment, XML reporting may be the default technique.

In step 403, an XSL stylesheet for transforming XML test results of the test executive sequence may be created. As described below, the XSL stylesheet may be used to transform XML test results of the test executive sequence. The stylesheet may be created in any of various ways, e.g., using a text editor or a development environment, such as Microsoft Developer Studio. In other embodiments, it may not be necessary to create an XSL style sheet. For example, in one embodiment, a plurality of pre-created XSL stylesheets may be supplied with the test executive software, and one of these pre-created XSL stylesheets may be specified. In another embodiment, the user may have previously created an XSL stylesheet that he wishes to re-use, and this existing XSL stylesheet may be specified. In another embodiment, the test executive software may supply a default XSL stylesheet which is suitable, and it may not be necessary to specify or create another XSL stylesheet.

In step 405, the test executive sequence may be executed. In executing the test executive sequence, the test executive software may generate various test results. In various embodiments, any of various types of test results may be generated. Examples of test results include Boolean pass/fail results for various steps in the sequence, numeric limit values computed by various steps, etc.

In step 407, one or more XML files specifying test results of the test executive sequence may be generated. In other words, the results of the execution of the test executive sequence may be represented in XML. The XML file(s) may be generated concurrently with or after the execution of the test executive sequence. In one embodiment, the XML file(s) may include all test results of the test executive sequence. In another embodiment, the XML file(s) may include only a portion of the test results. For example, when the test executive sequence was created, the user may have specified certain test results desired to be collected.

In step 409, the XML test results may be transformed using the XSL stylesheet, and the test results may be viewed. For example, the XML test results may be transformed into HTML code and may be viewed using a browser application, such as Microsoft Internet Explorer. In various embodiments, the XSL stylesheet may be used to transform the test results in any way desired, and the transformed data may be viewed or presented in any way desired.

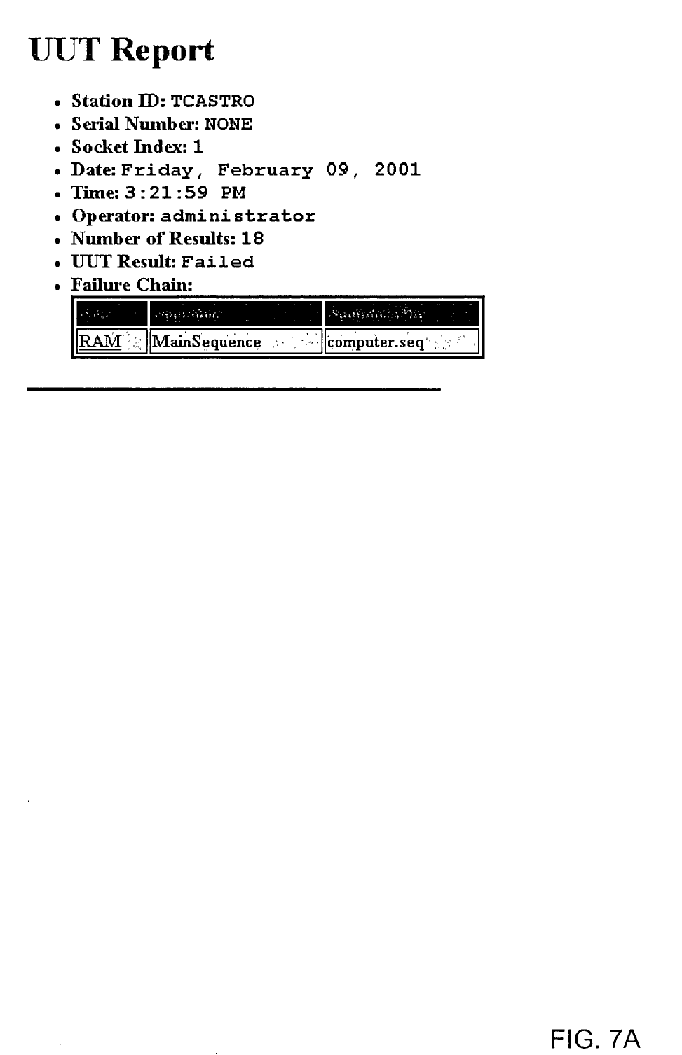

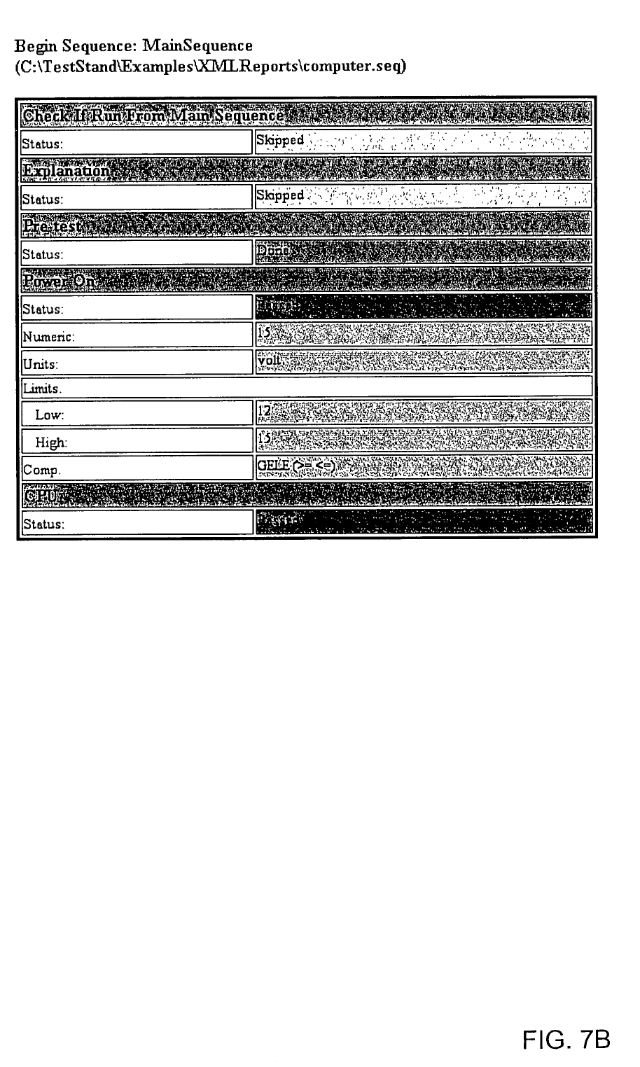

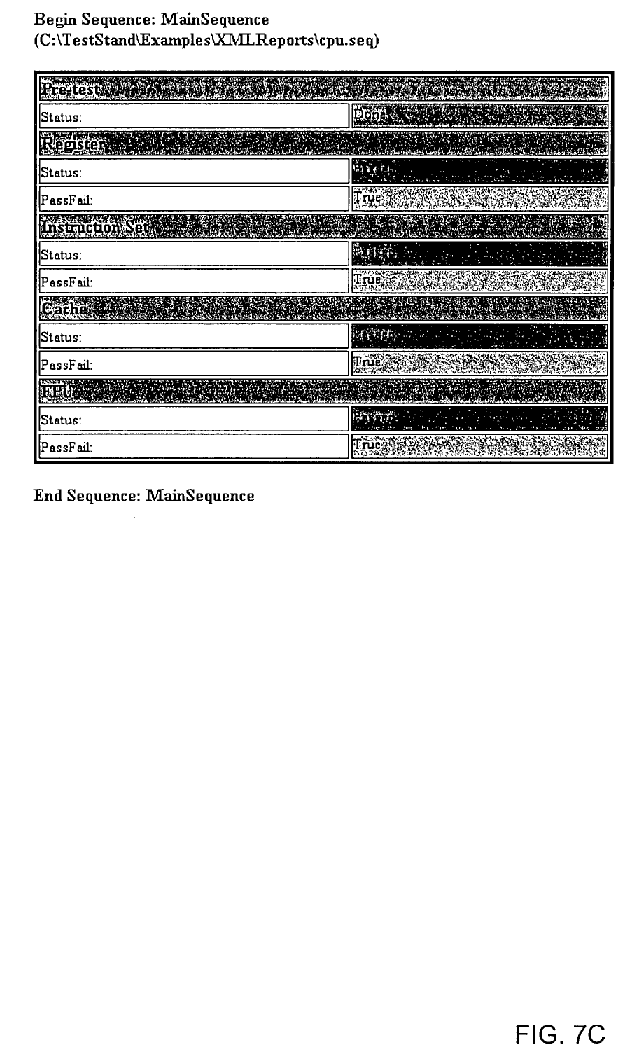

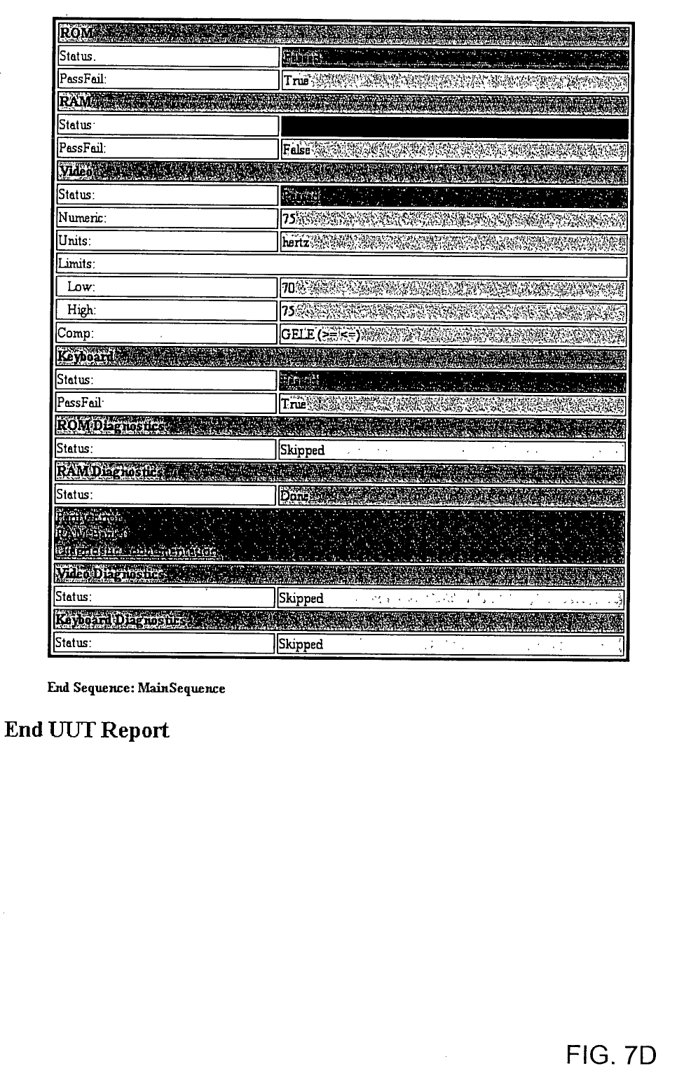

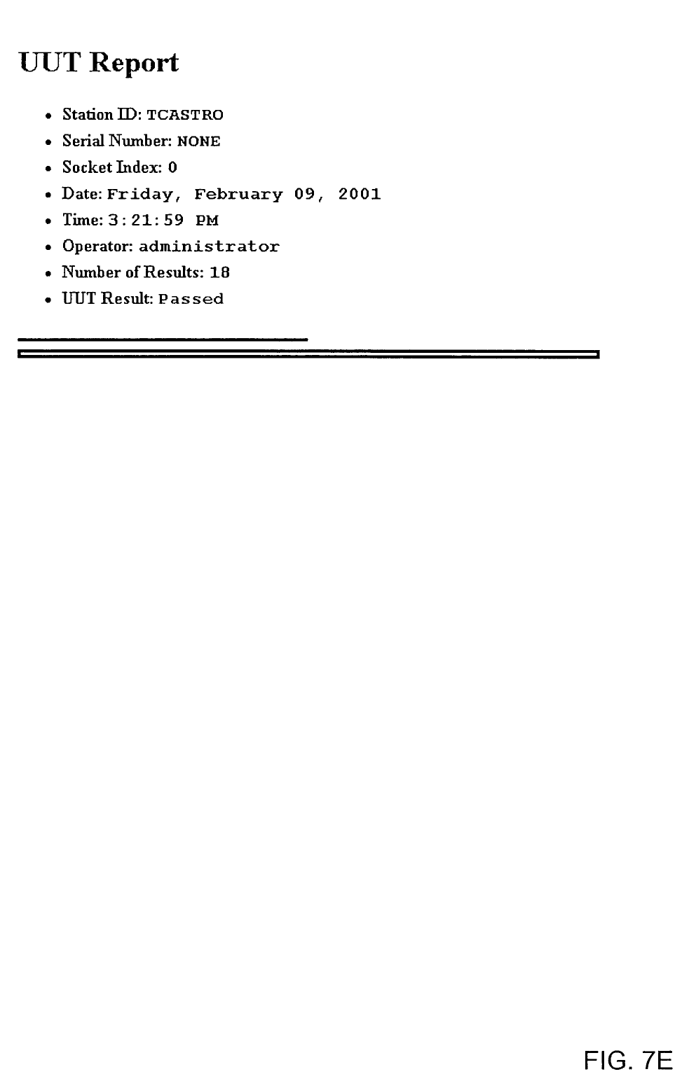

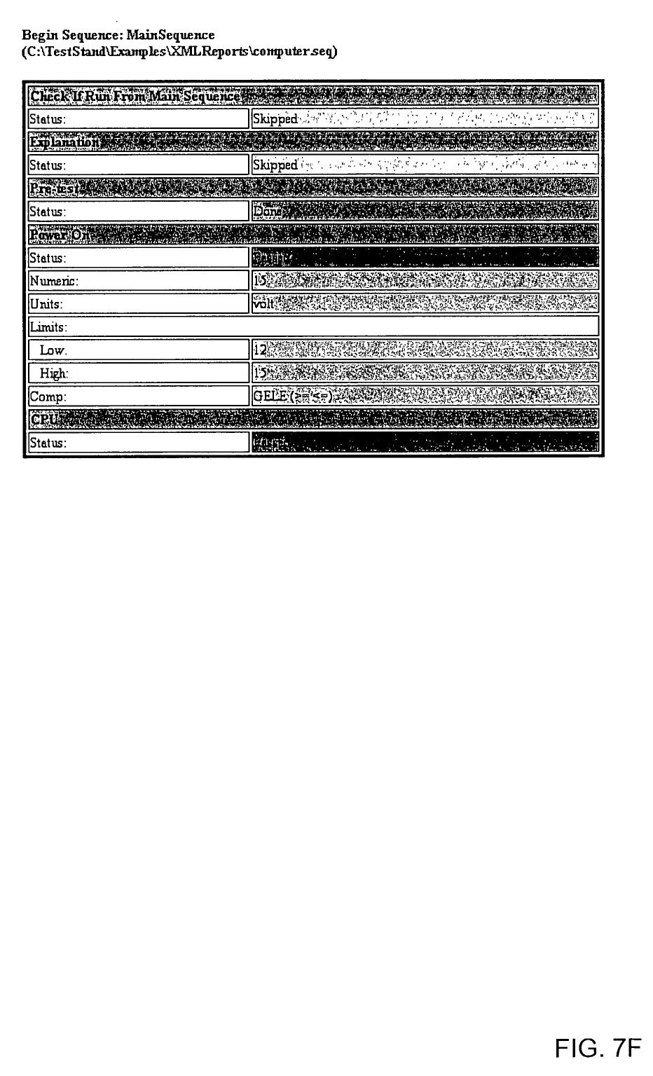

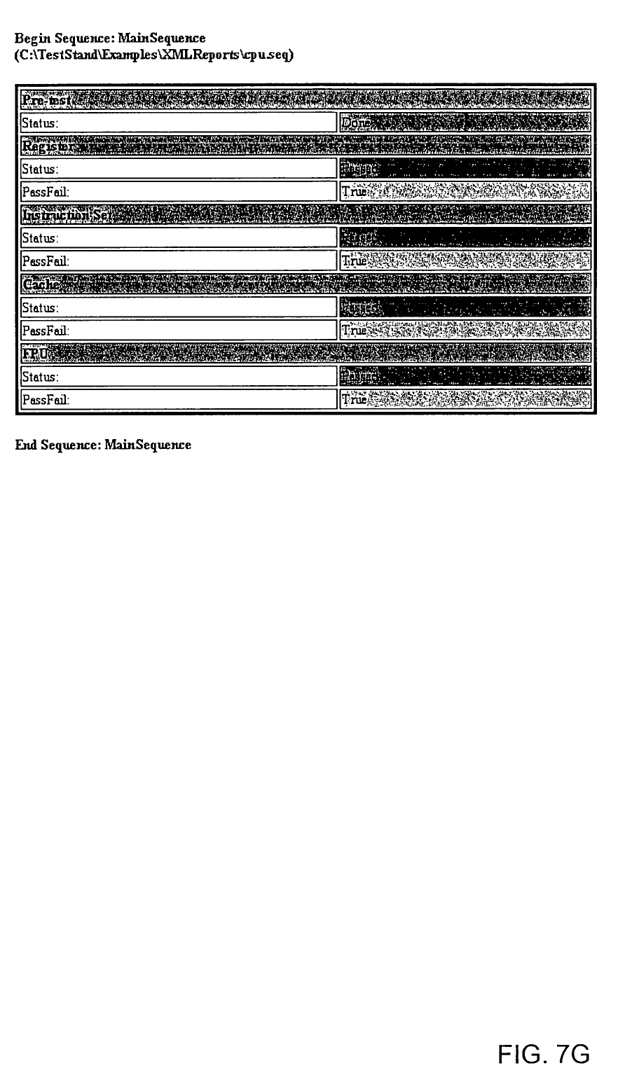

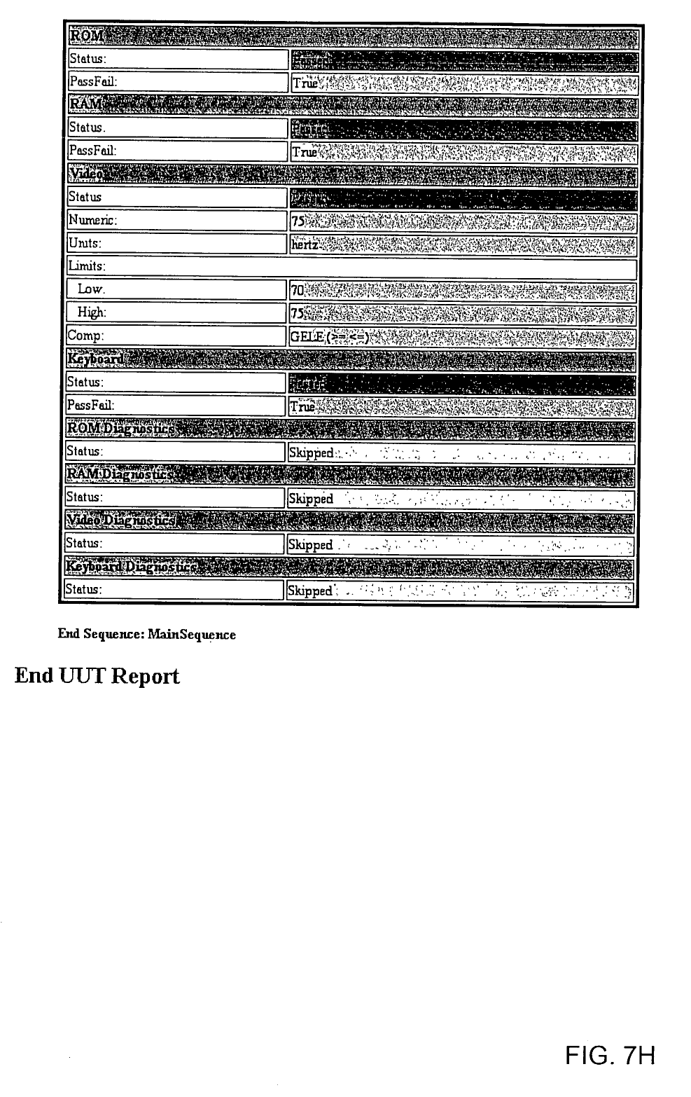

FIG. 7—Example XML Test Report

In various embodiments, the test executive software may generate any number of XML files, and the XML code in these files may be structured in any way desired. The XML code in computer program listing appendix A illustrates one example of XML test result data generated in response to executing a test executive sequence.

As described above, any desired XSL stylesheet may be used to transform the XML test result data. The XSL code in computer program listing appendix B implements a stylesheet for transforming the XML code of computer program listing appendix A into HTML code. FIG. 7 illustrates the resulting HTML code when viewed by the Microsoft Internet Explorer browser application.

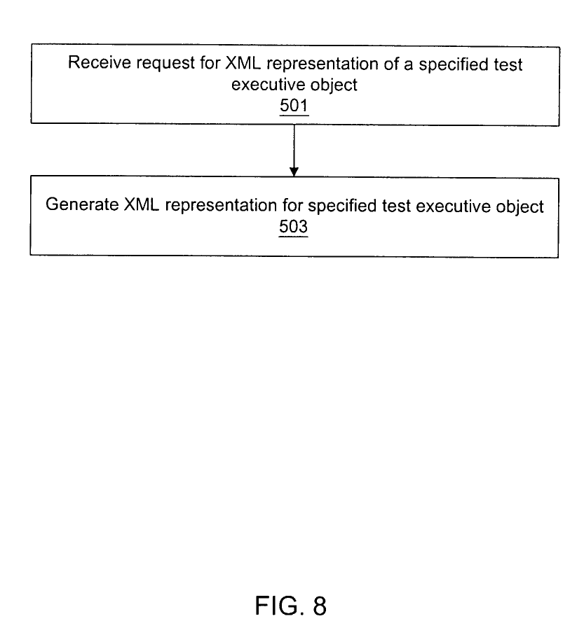

FIG. 8—Generating an XML Representation of a Test Executive Object

FIG. 8 is a flowchart diagram illustrating one embodiment of a method for generating an Extensible Markup Language (XML) representation of a test executive object. In various embodiments, the test executive software may define various types of objects used in performing tests of a system. For example, as described above, a test executive sequence may comprise a plurality of steps. These steps may be implemented as objects. In one embodiment, the test executive software may support the use of “step types”; thus, different types of steps may be implemented using different types of objects. Also, the sequence itself may be implemented as an object. Also, the test executive software may support the use of different pre-defined and/or user-defined data types, and these data types may be implemented as objects. In other embodiments, the test executive software may implement any of various other types of objects.

In step 501 of the method of FIG. 8, a request for an XML representation of a specified test executive object may be received. The test executive object may be specified in any of various ways, and the request for the XML representation of the object may be received in any of various ways. In one embodiment, the test executive software may provide an application programming interface (API), e.g., the engine API described above, that includes a function or method that takes an object as a parameter and generates an XML representation of the object. In another embodiment, each test executive object may have a method for generating the XML representation of that object.

In step 503, an XML representation for the specified test executive object may be generated. Generating the XML representation may comprise generating one or more XML files. In various embodiments, the XML representation may include as much or as little information about the object as desired. For example, in one embodiment, the XML representation may include enough information about the object to enable an identical object to be re-instantiated in memory, e.g., on a different computer system. In other embodiments, the XML representation may include only a portion of the object information.

The test executive software may be operable to generate an XML representation for one or more test executive object types implemented by the test executive software. In one embodiment, an XML representation may be obtained for every type of object implemented by the test executive software. In other embodiments, XML representations may be obtained for only certain kinds of objects.

An XML representation of a test executive object may be utilized for any of various purposes. For example, in one embodiment, an XML representation may be used to create a graphical presentation or view of a test executive object. For example, it may be desirable to view the object data to enable the data to be edited by a user. As another example, it may be desirable to create a view of the object data that can be published on the World Wide Web for viewing by others. An XSL stylesheet may be used in transforming the XML object data and creating the view. In one embodiment, a default XSL stylesheet may be provided for each type of test executive object. The use of the XML representation and the XSL stylesheet may together enable the test executive object to be graphically displayed without requiring any graphical user interface programming on the user's part.

In another embodiment, an XML representation of an object may be utilized for debugging purposes. For example, a user may request an XML file representation of a test executive sequence to be generated, so that the XML file can be sent to a technical support representative of the test executive software vendor. The technical support representative may use the XML file to re-create the test executive sequence and answer the user's questions.

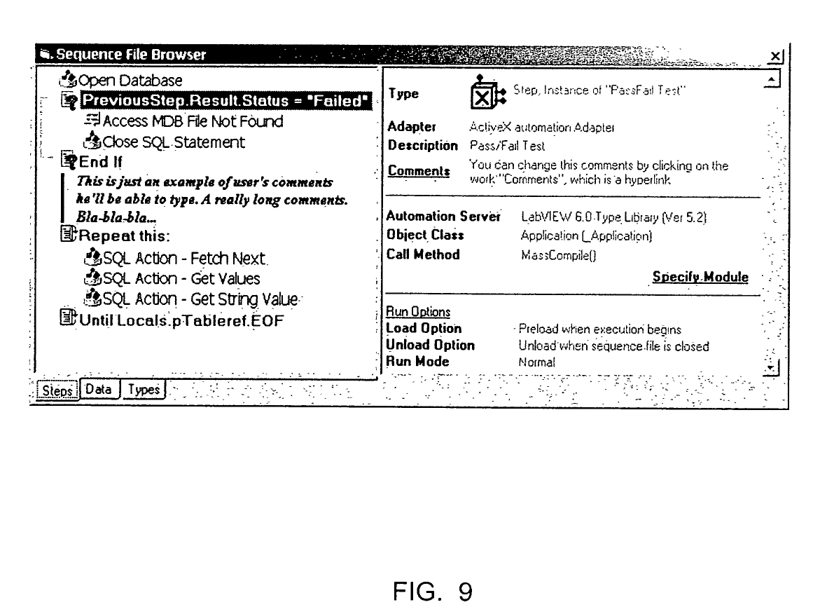

FIG. 9—Exemplary Use of XML Representation of a Step Object

As noted above, an XML representation of a test executive object may be utilized for any of various purposes. FIG. 9 illustrates a form showing an exemplary use of an XML representation of a test executive step object, i.e., an object that represents a test executive step. The left side of this form is a regular windows GUI control. In response to selecting a step object on the left, a .GetXML( ) method is called on the selected step object. An XSL stylesheet is then applied to the resulting XML representation of the object to generate an HTML page, which appears on the right side. The HTML page is displayed using the Microsoft web browser ActiveX control. The HTML page includes various hypertext links that the user can click on the edit various aspects of the step.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A method for enabling Extensible Markup Language (XML) reporting for a test executive sequence, the method comprising:
executing the test executive sequence;
generating XML test results for the test executive sequence; and
transforming the XML test results using an XSL stylesheet.

2. The method of claim 1,
wherein the test executive sequence comprises a plurality of test executive steps;
wherein said executing the test executive sequence comprises executing the plurality of test executive steps.

3. The method of claim 2,
wherein said generating XML test results for the test executive sequence comprises generating XML test results for the test executive steps.

4. The method of claim 1,
wherein said executing the test executive sequence comprises interacting with one or more hardware devices to test a unit under test (UUT).

5. The method of claim 1,
wherein the test executive sequence comprises a first test executive step operable to generate a Boolean pass/fail result;
wherein said generating XML test results for the test executive sequence comprises generating XML code specifying the Boolean pass/fail result generated by the first test executive step.

6. The method of claim 1,
wherein the test executive sequence comprises a first test executive step operable to generate a numeric limit value;
wherein said generating XML test results for the test executive sequence comprises generating XML code specifying the numeric limit value generated by the first test executive step.

7. The method of claim 6,
wherein said first test executive step generating the numeric limit value comprises the first test executive step performing a test of a unit under test (UUT) to determine the numeric limit value.

8. The method of claim 1, further comprising:
configuring result collection for only a portion of the test results for the test executive sequence;
wherein said generating XML test results for the test executive sequence comprises generating XML test results for only the portion of the test results for the test executive sequence.

9. The method of claim 1,
wherein said generating XML test results for the test executive sequence comprises generating one or more XML files specifying test results for the test executive sequence.

10. The method of claim 1, further comprising:
creating the test executive sequence prior to said executing.

11. The method of claim 1, further comprising:
creating the XSL stylesheet prior to said transforming.

12. The method of claim 1, further comprising:
viewing the results of said transforming the XML test results using the XSL stylesheet.

13. A memory medium for enabling Extensible Markup Language (XML) reporting for a test executive sequence, the memory medium comprising program instructions executable to:
execute the test executive sequence; and
generate XML test results for the test executive sequence.

14. The memory medium of claim 13,
wherein the test executive sequence comprises a plurality of test executive steps;
wherein said executing the test executive sequence comprises executing the plurality of test executive steps.

15. The memory medium of claim 14,
wherein said generating XML test results for the test executive sequence comprises generating XML test results for the test executive steps.

16. The memory medium of claim 13,
wherein the test executive sequence comprises a first test executive step operable to generate a Boolean pass/fail result;
wherein said generating XML test results for the test executive sequence comprises generating XML code specifying the Boolean pass/fail result generated by the first test executive step.

17. The memory medium of claim 13,
wherein the test executive sequence comprises a first test executive step operable to generate a numeric limit value;
wherein said generating XML test results for the test executive sequence comprises generating XML code specifying the numeric limit value generated by the first test executive step.

18. The memory medium of claim 13,
wherein said generating XML test results for the test executive sequence comprises generating one or more XML files specifying test results for the test executive sequence.

19. The memory medium of claim 13, further comprising program instructions executable to:
create the test executive sequence prior to said executing.
